(19) United States
(12) Patent Application Publication
(10) Pub. No.: US 2009/0161903 A1
(43) Pub. Date: Jun. 25, 2009

(54) Docking station capable of being mounted to a sports support pole

(75) Inventor: Ronald A. White, North Prairie, WI (US)

Correspondence Address: HOWREY LLP - East, C/O IP DOCKETING DEPARTMENT, 2941 FAIRVIEW PARK DR, SUITE 200, FALLS CHURCH, VA, 22042-2924, US

(73) Assignee: Russell Corporation, Atlanta, GA (US)

(21) Appl. No.: 12/004,481

(22) Filed: Dec. 21, 2007

(51) Int. Cl. H04R 1/02

(52) U.S. Cl. 381/395

(57) ABSTRACT

The present invention relates to a docking station mounted to a sports pole. The docking station includes a movable bracket to mount to the sports pole and a housing to detachably mount to the bracket. The housing includes at least one speaker to connect to a portable an audio device, allowing the audio device to provide audio output to the at least one speaker.

### FIELD OF THE INVENTION

The present invention relates in general to a docking station, and more particularly, to a docking station which is capable of being mounted to a sports support pole.

### BACKGROUND OF THE INVENTION

During a sporting activity, such as a basketball game, players may desire to listen to audio content while engaging in the sporting activity. In the past, this audio content has been provided by conventional radio, tape players, compact disc (“CD”) players, or portable media players (“PMPs”) capable of playing stored audio content. PMPs are quickly becoming the preferred audio reproduction means due to their advantages over other more conventional devices. For example, PMPs allow users to maintain a vast amount of music maintained in audio libraries on the device itself.

Typically, PMPs are provided with a headphone jack which allows an individual to attach the PMP to their body and listen to audio content through headphones. However, it is also common for PMPs to be configured with an audio output port which allows the PMP to be connected to a docking station such that multiple users can listen to the same audio content. Furthermore, some docking stations connect directly to the headphone jack for receiving audio output. These docking stations often must be connected to an outside power source to conserve the power of the PMP and extend playing time.

For individuals who are engaging in a sporting activity and desire to simultaneously utilize a docking station for listening to audio content, prior docking stations present many disadvantages. For example, a power outlet may not be in close proximity to the location of the sporting activity and, as such, it may be necessary to string wires from a distant location to the docking station in order to provide power. These wires may create a hazardous tripping risk for players or observers who may have to step over or near the placement of the wires.

Additionally, prior PMP docking stations may not be built ruggedly enough to handle collisions with a player or ball. As such, the risk of damage to the docking station or the PMP is increased when they are used near the location of a sporting activity.

Another drawback of existing docking stations is that they may be difficult to position for optimum audio coverage of the playing area. It may be time-consuming and cumbersome for the user to set up the speaker system and additionally, set up and connect the PMP or other audio device and docking station such that risk of damage to the apparatus and/or player is minimized and that the players can still sufficiently hear the content from the PMP or other audio device. Likewise, it may be just as time-consuming and cumbersome for the user to take down the speaker system, PMP or other audio device, and docking station upon the conclusion of the sporting activity.

Thus, there is a need for a simple docking station for accepting a PMP or other audio device and playing its audio content near a sporting activity, such as a basketball court, with minimal risk of damage to the docking station, PMP or other audio device while still maintaining maximum coverage of the audio content and allowing for easy removal and storage of the unit.

### SUMMARY OF THE INVENTION

The present invention relates in general to a docking station, and more particularly, to a docking station which is capable of being mounted to a sports support pole.

One embodiment of the present invention may include a pole mountable docking station for an audio device. The pole mountable docking station may include a bracket mountable to a sports support pole and a housing configured to detachably attach to the bracket and support the audio device. The housing may include at least one speaker connectable to the audio device. The connection between the audio device and the at least one speaker may allow the audio device to provide audio output to each speaker during a sporting event.

These and other objects and advantages of the invention will be apparent from the following description, the accompanying drawings and the appended claims.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a view of a docking station according to one embodiment of the present invention;

FIG. 2A is another view of a docking station according to one embodiment of the present invention;

FIG. 2B illustrates a docking station attached to a basketball sports support pole according to one embodiment of the present invention;

FIG. 3 is a view of a pole bracket according to one embodiment of the present invention;

FIG. 4 is another view of a pole bracket according to one embodiment of the present invention;

FIG. 5 is another view of a docking station according to one embodiment of the present invention; and

FIG. 6 is a view of a docking station and a PMP according to one embodiment of the present invention.

### DETAILED DESCRIPTION OF THE INVENTION

The present disclosure will now be described more fully with reference to the Figures in which various embodiments of the present invention are shown. The subject matter of this disclosure may, however, be embodied in many different forms and should not be construed as being limited to the embodiments set forth herein.

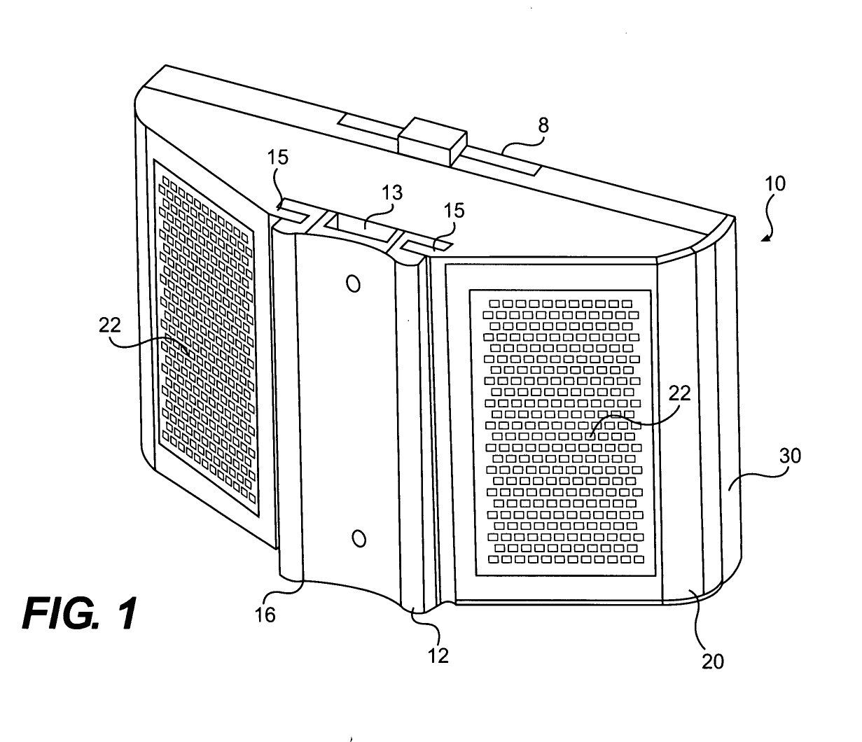

FIG. 1 is a view of a docking station according to one embodiment of the present invention. While the description of the docking station herein only describes the present invention with respect to a PMP, one of ordinary skill in the art that the docking station according to the present invention may be utilized with any type of portable device capable of providing audio signals. Such devices include, but are not limited to, compact disc (“CD”) players, tape players, minidisk players, digital music players (such as ipods or MP3 players), cellular telephones, personal digital assistants (“PDAs”) or any other portable audio device.

As shown in FIG. 1, the docking station is provided with a housing 10 having a front portion 20 and a back portion 30 capable of engaging with a pole bracket 16. Speakers 22 may be positioned within the front portion 20 of the housing 10. In alternate embodiments, however, it is contemplated that the speakers 22 may be orientated in any portion of the housing 10 including, but not limited to, the sides, top, bottom or the back portion of the housing depending on the desired direction(s) in which the sound is to be produced. Furthermore, it is contemplated that any number of speakers orientated at any location within the housing may be utilized without deviating from the scope and spirit of the present invention.

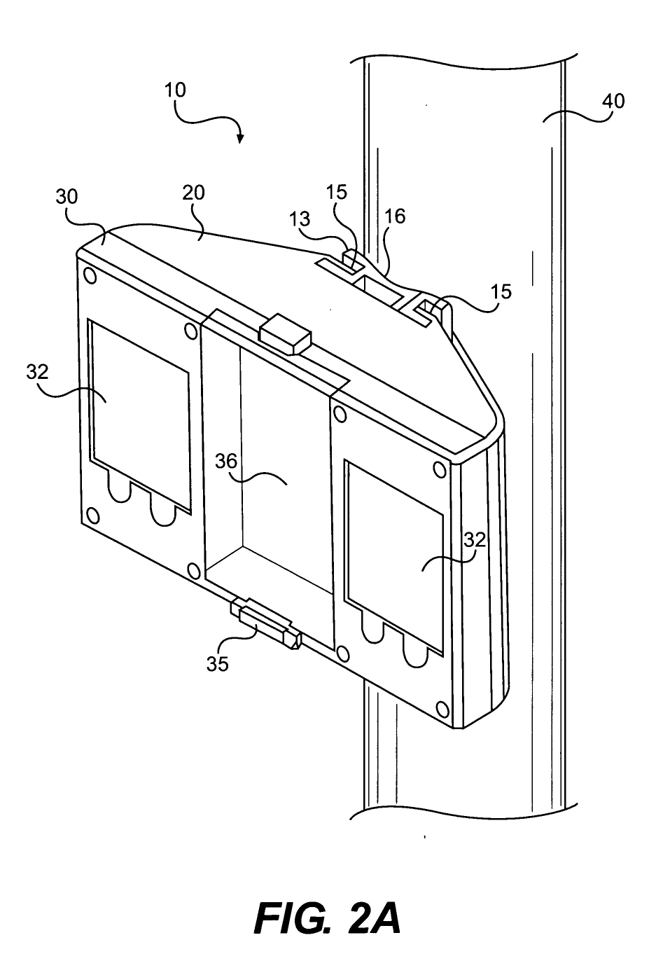

As shown in FIG. 1, the pole bracket 16 is configured to engage with the front portion 20 between speakers 22. One skilled in the art would understand, however, that the pole bracket 16 may engage the docking station elsewhere on the housing 10. In the embodiment illustrated in FIG. 1A, the pole bracket 16 is configured to be mounted to a sports support pole 40 (as shown in, and discussed with respect to FIGS. 2A and 2B). The pole bracket 16 may include a curved side 12 to fit the contour of a round sports support pole 40. However, it is contemplated that the pole bracket 16 may also be shaped to fit the contours of a pole having an outer contour having any shape including, but not limited to, a square contour.

A guide slot 13 and bracket guides 15 are positioned between the speakers 22 to allow the housing 10 to slidably engage with the pole bracket 16, thus allowing the pole bracket 16 to be mounted to the pole while the housing 10 may be removed for storage (as discussed in detail below). One skilled in the art would understand that the housing 10 may be removably connectable to the pole bracket 16 by other means known in the art including, but not limited to, suction cups, cup and ball attachments or any other conventional means of removably attaching two devices.

FIG. 2A is another view of a docking station according to one embodiment of the present invention. As shown in FIG. 2A, the back portion 30 of the housing 10 may include battery compartments 32 and a recess 36 for receiving a PMP. Battery compartments 32 are provided to house batteries (not shown) for providing power to the speakers. Furthermore, the batteries (not shown) may be utilized to provide power to a PMP. While the present invention shows the batteries located within the back portion 30 of the housing 10, it is contemplated that the batteries may be positioned elsewhere on the housing 10, separately on the pole 40, or in a location which is remote from the housing 10. Further, as one skilled in the art will understand, the present invention could be produced without batteries, using only the power of a PMP, or with an external electrical source such as a household current.

In FIG. 2A, the recess 36 is provided on the back portion 30 of the housing 10 to house a PMP. The recess 36 may, however, be positioned elsewhere on the docking station. In an alternate embodiment, the recess may be positioned with an opening on top or on the side of the housing 10. It should be clear that it is contemplated that the docking station does not require the use of a recess to house a PMP, but that a PMP could be positioned on an outer portion of the housing 10 or at a location which is remote from the housing 10.

A recess door (not shown) may be provided to cover and protect a PMP when it is placed within the housing 10. In one embodiment, the recess door may pivot about a hinge 35 (as shown in FIG. 2A) between opened and closed positions (not shown). Furthermore, the recess and recess door may be provided with a seal to provide protection to the PMP from weather and moisture while the PMP is within the recess. It is also contemplated that the docking station may be provided with a sliding or removable recess door to cover a PMP, or the PMP or other audio device may slide into the recess such that a door is not required. It is contemplated that the recess door may be transparent so that a user can observe an LCD, screen, or other display, on a PMP. One skill in the art would understand, however, that the recess door may also be made of other commercially available materials.

As illustrated in FIG. 2B, the docking station may be mounted to a basketball sports support pole 40. The sports support pole 40 may be used to support a basketball goal which includes a backboard 46 and a rim 44 having a net. However, it is contemplated that the docking station may be mounted to other sports support poles used in sporting activities including, but not limited to, volleyball, tennis, soccer, hockey, or lacrosse support poles, without deviating from the scope and spirit of the present invention.

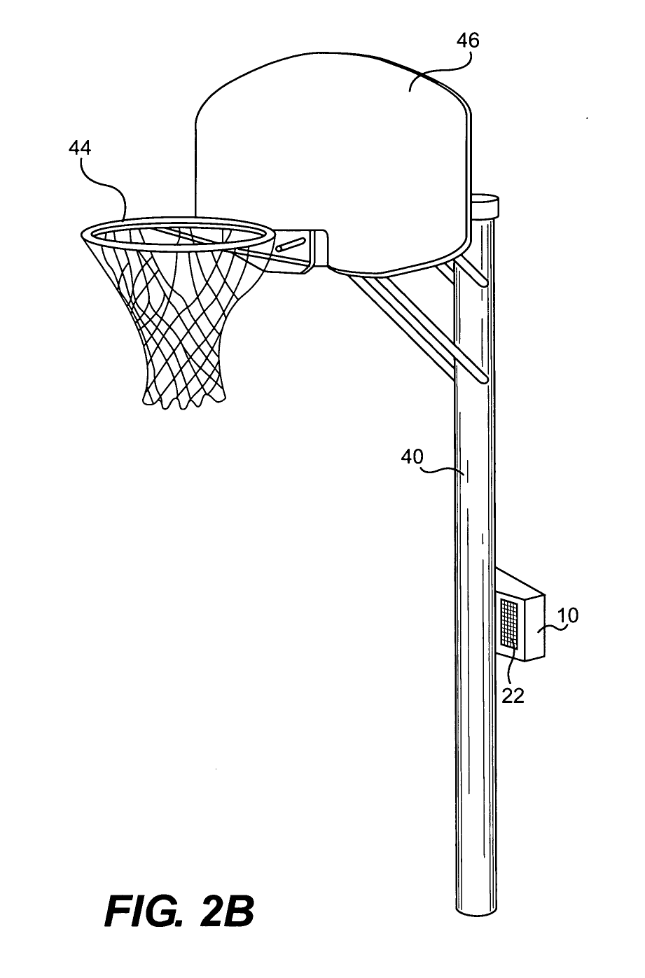

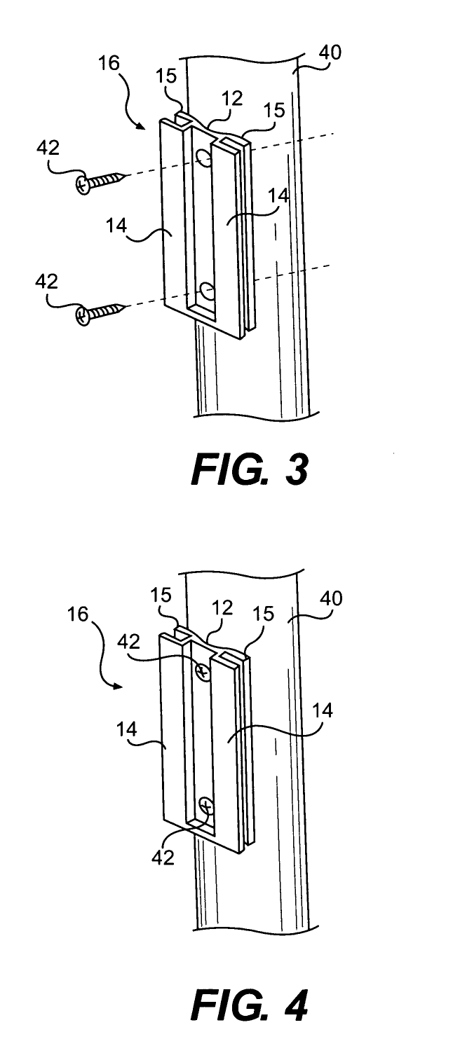

FIGS. 3 and 4 are views of the pole bracket 16 according to one embodiment of the present invention. As shown in FIGS. 3 and 4, the pole bracket 16 is mounted to the pole 40 using screws 42 to secure the pole bracket 16 to the pole 40. One skilled in the art would understand, however, that the pole bracket 16 may be mounted to the pole 40 using other fastening or securing devices. Further, it is contemplated that the pole bracket 16 may be mounted to the pole 40 using a fastening or securing device to allow the pole bracket 16 to be mounted at various positions on the pole 40. This may include the use of U-shaped brackets, tension cords, wires or any other type of fastening means known to one of skill in the art. Additionally, it should be noted that the docking station may be positioned at any desired vertical position along the sports support pole 40 in order to maximize audio output from the docking station as well as ease of use of the docking station and PMP.

As mentioned above, the pole bracket 16 may be configured with a curved side 12 to fit onto the pole 40, as shown in FIGS. 3 and 4. The curved side 12 is configured as such to maximize contact of the pole bracket 16 against the pole 40 and prevent the possibility of the bracket being bent against the pole or otherwise damaged. As discussed above, however, it is contemplated that the pole bracket 16 may be configured differently to maximize contact with poles having other shaped outer surfaces—e.g., flat for a pole with a flat outer surface.

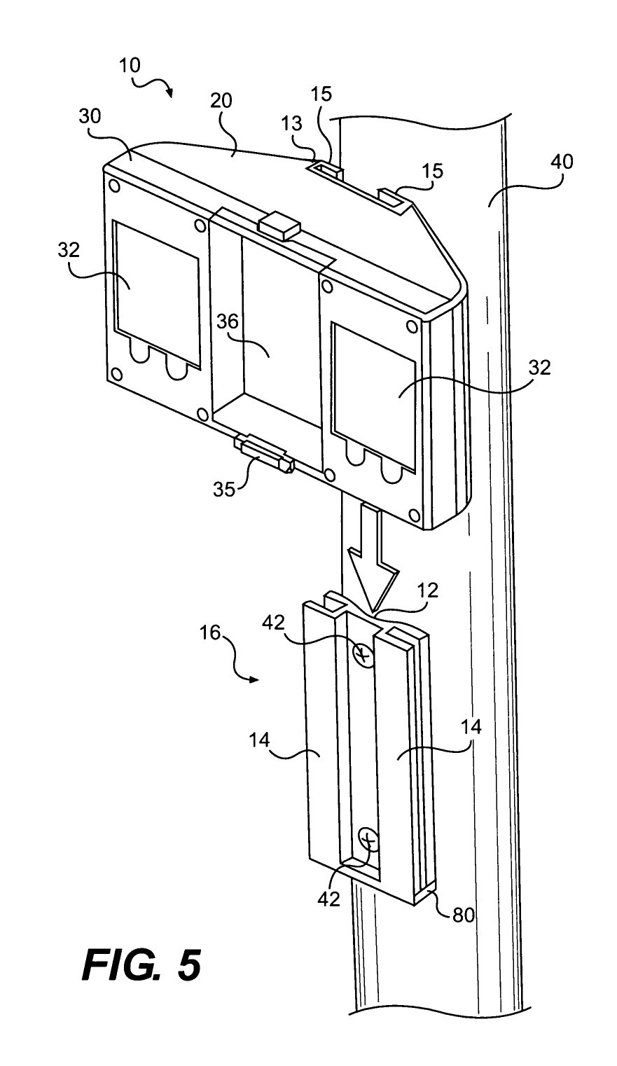

FIG. 5 is another view of a docking station according to one embodiment of the present invention. As shown in FIG. 5, the housing 10 is configured with the bracket guides 15 to guide the housing 10 onto the pole bracket 16. The pole bracket 16 may be configured with end projections 14 to abut the bracket guides 15 of the housing 10. Furthermore, end projections 14 may include one or more stops 80 to ensure the docking station is retained by the end projections 14.

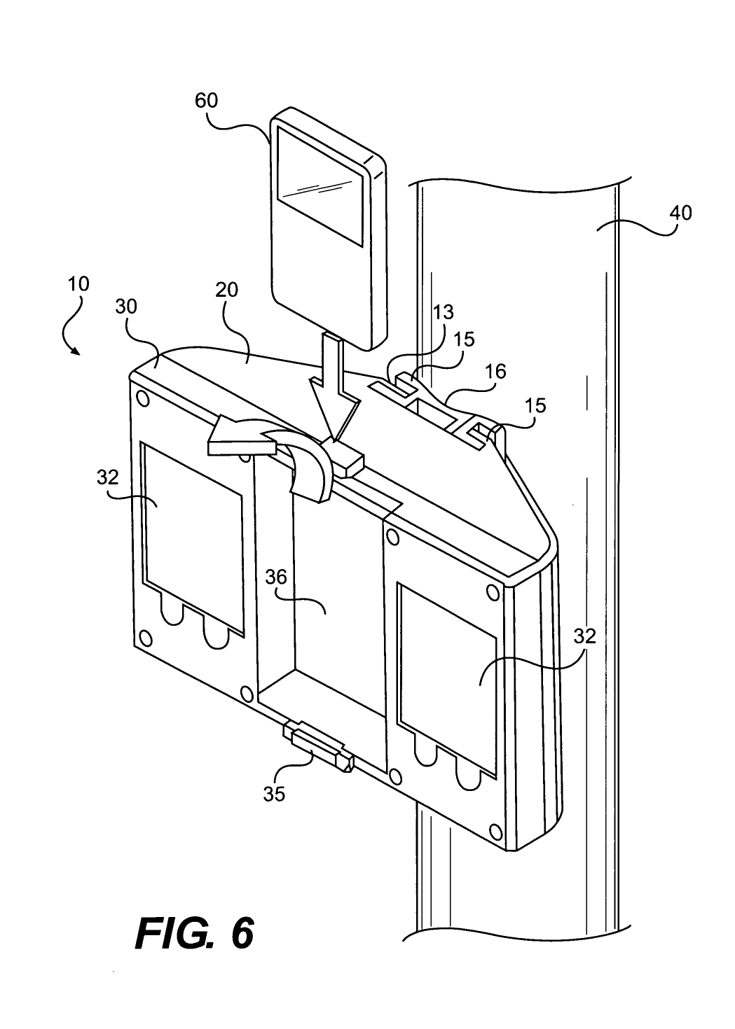

FIG. 6 is another view of a docking station, according to one embodiment of the present invention. As shown in FIG. 6, a PMP 60 may be placed in recess 36. As mentioned above, while the figures illustrate the use of a PMP, it is contemplated that other audio playback devices may be used with the docking station according to the present invention.

When the PMP is placed within the recess 36, the PMP may be connected to the docking station using an audio input jack or port (not shown). This may include, but is not limited to, a jack or port for connecting to the headphone jack or other audio output port on the PMP. Furthermore, as discussed above, the PMP may be connected to the docking station such that power from the docking station is used to power the PMP. Alternatively, the power from the PMP may be used to power the speakers 22 in the event that the batteries are incapable of providing power or in the event that no batteries are provided in the docking station.

In one embodiment, the connection of the PMP to the docking station may be accomplished using a cord or cable which protrudes from the docking station. In other embodiments, the connection to the docking station may be accomplished using a protruding connection which is configured to fit into a port located on the PMP. Further, multiple connections may be provided to transfer different types of signals between the PMP and the docking station including, but not limited to, data signals, audio signals and power. In short, it is contemplated that any known means of connecting a PMP to a docking station may be utilized according to the present invention to transfer audio, data or power between the PMP and the docking station without deviating from the scope and spirit of the present invention.

A power switch or button (not shown) may also be provided on the housing 10 to activate the docking station. The power switch or button could be located in the recess 36 or elsewhere on the housing 10. The power switch or button could be a conventional push button or toggle switch or other on/off means known in the art. Moreover, it is contemplated that the present invention could include, but is not limited to, a remote control unit known in the art to activate the docking station.

The present invention may also be configured with a volume control (not shown) to control the volume of the docking station. It is contemplated that the present invention may be configured with a volume control mechanism known in the art, or configured such that the volume could be solely controlled by the PMP when the PMP is connected to the docking station.

The foregoing descriptions of specific embodiments of the present invention are presented for purposes of illustration and description. They are not intended to be exhaustive or to limit the invention to the precise forms disclosed. Obviously, many modifications and variations are possible in view of the above teachings. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims appended hereto, and by their equivalents.

What is claimed is:

1. A pole mountable docking station for an audio device, comprising:
a bracket mountable to a sports support pole; and
a housing configured to detachably attach to the bracket and support the audio device, the housing including at least one speaker connectable to the audio device;
wherein the connection between the audio device and the at least one speaker allows the audio device to provide audio output to each speaker during a sporting event.

2. The docking station according to claim 1, wherein said audio device is a personal music player.

3. The docking station according to claim 1, wherein the housing includes a docking compartment to hold the audio device.

4. The docking station according to claim 1, wherein the housing comprises a means for protecting the audio device.

5. The docking station according to claim 4, wherein the means for protecting the audio device is configured to allow a user to view information provided on a display of the audio device.

6. The docking station according to claim 1, further comprising:
means for providing power to the docking station.

7. The docking station according to claim 6, wherein the means for providing power provides power to each speaker.

8. The docking station according to claim 6, wherein the means for providing power provides power to the audio device.

9. The docking station according to claim 1, wherein the housing is capable of being positioned at a plurality of locations on the sports support pole to maximize audio output from the docking station.

10. The docking station according to claim 1, wherein the bracket is mountable to a basketball support pole.
